(19) United States
(12) Patent Application Publication
(10) Pub. No.: US 2011/0240893 A1
(43) Pub. Date: Oct. 6, 2011

(54) Valve Actuator Having Synchronous Motor Having Plastic Bushings

(75) Inventor: William P. Windgassen, South Beloit, IL (US)

(73) Assignee: SCHNEIDER ELECTRIC BUILDINGS, LLC, Loves Park, IL (US)

(21) Appl. No.: 12/753,181

(22) Filed: Apr. 2, 2010

(51) Int. Cl. F16K 31/04; F16K 51/00; H02K 21/24

(52) U.S. Cl. 251/129.13; 251/129.02; 310/156.37

(57) ABSTRACT

A synchronous motor and a valve having a valve actuator and valve assembly is provided. The valve actuator includes the synchronous motor. The synchronous motor utilizes a magnetic coil, a stator and a rotor to generate rotational movement to drive the valve member for the valve assembly. The valve has a normal state in which the valve is maintained when power is not supplied to the motor. The valve has a non-normal actuated state when power is supplied to the motor. The motor is stalled in the non-normal state to maintain the valve in that state. The rotor includes a rotor shaft that passes through a magnetic hub of the stator. The rotor shaft is supported by a plurality of plastic and/or nylon bearings to prevent corrosion therebetween when the rotor shaft and bearings remain in a substantially fixed orientation for an extended period of time.

### FIELD OF THE INVENTION

This invention generally relates to valve actuators and synchronous motors and more particularly to valve actuators using synchronous motors.

### BACKGROUND OF THE INVENTION

Valves are used in a variety of applications to control fluid flow. Typically, a valve includes a movable valve member disposed within an internal passage or cavity in communication with a fluid line, and the valve member is movable in response to an actuator to vary the position of the valve member to control the flow of fluid in the line.

One type of valve utilizes a valve body adapted to be plumbed into a line, to which a valve member is mounted for movement through a range of operating positions to control flow of fluid through the valve body in response to operation of an actuator assembly. Typically, the valve member is movable between an open position and a closed position, and the valve member is mounted to an operating member such as a valve stem, which in turn is pivotably mounted to the valve body. The valve stem in turn is interconnected with a valve actuator assembly which controls pivoting movement of the valve stem to thereby move the valve member through its range of operating positions.

The valve actuator assembly generally includes a housing, a motor mounted within the housing and including an output, a drive mechanism mounted to the housing and interconnected with the motor output through a plurality of speed reducing gear stages. The drive mechanism in turn is interconnected with the valve stem, such that operation of the motor results in movement of the drive mechanism, through the motor output, to thereby cause movement of the valve stem through the drive mechanism.

In some embodiments, these valves are considered normally open or normally closed such that when power is removed from the valve actuator assembly, the valve actuator assembly will automatically return to a normal position. In a normally closed valve, the actuator will return such to a normal state in which the actuator closes the valve. Conversely, in a normally open valve, the actuator will return to a normal state in which the actuator opens the valve. Typically, this operation is done by a spring that is biased by the motor of the valve actuator when the valve is moved away from the normal state. Once power is lost, the spring will return the actuator and consequently the valve to the normal state. These types of valve arrangements are disclosed in, for example, U.S. Pat. No. 6,073,907 to Schreiner, Jr. et al. and owned by the Assignee of the instant application, the teachings and disclosure of which are incorporated herein by reference.

These valves find particular use in heating and air conditioning systems for buildings where the valves control the flow of heating or cooling fluid throughout the building. During warm periods, the valves in the hot water lines will be closed and the valves in the cold water lines will be opened. Conversely, during cool periods, the valves in the hot water lines will be opened and the valves in the cold water lines will be closed. These warm and cool periods may extend for 3 or more months and in some environments these periods may extend for more than 6 months.

Consequently, the valves can be maintained out of the normal state (i.e. a non-normal state) for these extended periods of time. To maintain the valve in the non-normal state, power is continually supplied to the motor of the valve actuator assembly for the entire time period to prevent the valve actuator assembly returning to the normal state. During this period, the motor will be stalled maintaining the valve in the non-normal state due to the continuously supplied power.

Because the motor will be stalled for an extended period of time, in some instances in excess of 6 months, the valve actuator assemblies typically use synchronous motors (also referred to as clock motors) of the kind generally disclosed in U.S. Pat. Nos. 3,310,696; 2,256,711; 2,295,786; 2,283,363; 2,374,347; 2,450,955; and 2,305,963 to W. L. Hansen et al., the teachings and disclosures of which are incorporated herein by reference.

These synchronous motors have relatively high rotational speeds coupled with relatively low torque which requires numerous gear stages between the motor and the valve stem such that the high speed can be translated into high torque. Further, these synchronous motors operate on alternating current such that when the synchronous motors are stalled, i.e. when the valve is maintained in the non-normal state, the synchronous motors are exposed to microscopic fretting (i.e. microscopic alternating rotational movement). This is particularly true in the application of the instant valve arrangements because the numerous gear reductions from the motor to the valve stem provide for increased flexure within the gear train formed thereby which further permits the rotational movement during the fretting process.

The Applicant and Assignee of the instant invention became aware of a significant failure problem within these valve arrangements such that when the valves were maintained in the non-normal state for extended periods of time (i.e. a full cool or warm period), the valves would stick and not return to the normal state.

The invention provides such an improved synchronous motor and a valve arrangement using such a synchronous motor that has solved a long felt but unresolved need to which the solution of which was met with great skepticism by leaders in the industry.

### BRIEF SUMMARY OF THE INVENTION

The Applicant of the instant application has determined significant problems related to this valve design, and particularly, with the use of the synchronous motors to maintain the valves in the non-normal state for extended periods of time. The Applicant has determined numerous problems with the prior art designs that have caused these valves to stick in the non-normal state such that the valve actuator cannot return to the normal state once power is removed from the motor.

The Applicant has also determined the solution to the sticking problem as the Applicant has determined, in significant disbelief and after significant skepticism and resistance by a leading manufacturer in the industry, a cause and solution to the sticking problem. Further, when the Applicant addressed this sticking problem with the leading manufacturer in the industry, the industry leader indicated that they have been working on fixing this problem on and off for many years but have not been able to fix it.

The Applicant has determined that due to the fretting action of as these motors when in the stalled state, a powder substance is generated between the rotor shaft of the motor and the bearings that support the rotor. The powder increases the friction between the rotor shaft and the bearings such that the spring cannot return the actuator to the normal state.

This increased friction is amplified due to the location of the spring that returns the valve to the normal state within the gear train between the motor and the valve stem. Because the motor is low torque, the spring is typically located downstream from the motor within the gear train at least 3-4 speed reduction stages (i.e. torque amplifications) within the gear train. However, when viewed from the spring, any upstream friction is similarly magnified through those 3-4 speed reductions. Thus, a small incremental increase in friction at the motor provides a significant load that the spring must overcome to return the assembly back to the normal state.

When the applicant presented this sticking problem to the industry leader, the applicant was repeatedly told that the problem related to anything other than what the applicant determined to be the problem. The applicant was told that the formation of the powder was material wear at the interface between the rotor shaft and the bearings. The industry leader told the Applicant to use an improved grease. They have tried alternate grease under the assumption that the high heat caused the current grease to evaporate and separate. Numerous different greases were tried unsuccessfully. Due to the extremely limited amount of relative movement between the shaft and the bearings during fretting, a grease arrangement will not fix this fretting issue. For a grease to get between the shaft and the bearing, there needs to be significant relative movement to draw the lubricant therebetween. However, this fix did not work on the microscopic level present in the stalled state of the motor.

Further, the industry leader tried altering motor orientation as well as trying different grounding arrangements, such as both grounded motors and ungrounded motors.

Further, the industry leader attempted to fix the problem by using cooler operating magnetic coils to impart less heat under the assumption the heat aggravated the failures. This did not work either.

However, the applicant determined that this was not a wear problem. For wear to occur, there would need to be a significant side load presented to the rotor shaft driving the shaft into the surface of the bearing. However, in the stalled state this side load is not present such that an insignificant amount of force is provided such that the bearing material or the shaft material will not be worn away to cause the powder formation.

Without any significant progress or answer from the manufacturers of these motors, the Industry leader told the applicant to tell the customers to not use the product this way, namely leaving the motor stalled for an extended period of time. Clearly, this is not a feasible solution due to the operational environment of needing to provide proper heating or cooling fluid. As such, the Applicant had the motor analyzed with a focus on damage to the rotor shaft and the bearings. The analysis determined that the powder build up included oxidized metal (rust). Thus, it was not wear that was causing the build up of powder, instead, it was determined that a significant problem was the presence of corrosion rather than straight wear.

The applicant believes that this corrosion is caused primarily by fretting corrosion, but could be also caused by galvanic corrosion due to the interface of two different metals as well as to magnetically generated electrical stray current running across the bearing to loop the electrical coil due to the use of the A.C. current to drive the motor and lack of symmetry in the magnetic flux coil loop.

Because the material is corrosion rather than straight worn material, the corroded surfaces, oxides, form a light bond with the rest of the material that can be easily wiped away from the rest of the shaft or bearings. During the fretting action, the oxide, unlike the standard base material, could be easily wiped away, as opposed to what would be required for normal wear. As the powder oxide is wiped away, more surface is exposed to promote further corrosion. As the corrosion was continuously wiped away more and more corrosion was occurring and increasing the friction between the shaft and the bearings. Further, corrosion promotes the sticking problem more than straight wear because corrosion has a larger volume than straight wear due to the inclusion of the oxygen molecules thereby more quickly packing the space between the shaft and the bearings with powder particulates increasing the frictional forces.

Unfortunately, due to the “stalled” state, the rotor shaft and bearings were never exposed to significant relative motion in magnitude such that these particulates could be removed from between the two structures and/or to draw in more lubricant to prevent the corrosion and reduce resistance therebetween.

In view of the determination that the problem was corrosion, and believed to be primarily fretting corrosion, rather than wear, the Applicant suggested using plastic or nylon based bearings rather than the metal bearings that have been previously used. The Applicant was met with significant resistance by the industry leader and told that plastic bearings would not work and thus the industry leader provided significant resistance to using plastic bearings. The industry leader dismissed this solution on the premise that they believed that it would not work because they did not believe that corrosion and the interface between the metal bearings and the metal rotor shaft was the problem.

The Applicant believed that the use of plastic bearings would provide a natural lubricious surface such that the failure to draw lubricant between the bearing shaft interface would be significantly reduced. Further, the use of plastic bearings would significantly reduce the issue regarding fretting corrosion as the plastic bearing would prevent corrosion of that surface as well as prevent wiping away the oxidized surface of the rotor shaft.

It is believed that the use of a plastic bearing will reduce the frictional problems such that the valve arrangements will be less susceptible to the sticking problem.

With that being said, in one embodiment a new and improved valve is provided that utilizes a synchronous motor having plastic bearings.

In a more particular embodiment, the valve includes a valve assembly including a valve member moveable between open and closed positions. The valve further includes a valve actuator operably coupled to the valve member to drive the valve member between the open and closed positions. The valve actuator has a default normal position corresponding to one of the open and closed positions and a non-normal actuated position corresponding to the other one of the closed and open positions. The valve actuator includes a synchronous motor for driving the valve member and a gear assembly operably coupled between the motor and the valve member to transfer the rotational output of the synchronous motor to the valve member. The synchronous motor also includes a magnetic coil for generating alternating magnetic flux. The motor includes a stator arrangement including a magnetic hub surrounded by the magnetic coil. The stator arrangement also includes an upper disc and a lower disc attached proximate a first end of the magnetic hub. The upper disc includes upper radially extending pole pieces and the lower disc includes lower radially extending pole pieces. The upper and lower radially extending pole pieces alternating angularly. An undulating shielding disc is interposed between adjacent upper and lower radially extending pole pieces. The undulating shielding disc passes above the lower radially extending pole pieces and below the upper radially extending pole pieces shading the upper pole pieces. The stator includes a set of shielded and set of unshielded axially extending pole pieces and an undulating shielding ring interposed between adjacent ones of the shielded and unshielded pole pieces such that the shielding ring passes over a radially outer surface of the unshielded axially extending pole pieces and radially inward of a radially inner surface of the shielded axially extending pole pieces. The synchronous motor further includes a rotor including a rotor shaft coupled to an annular magnetic flange. The magnetic hub includes a pair of plastic bearings mounted therein to reduce corrosion effects due to fretting corrosion when the motor is in a stalled state. The rotor shaft passes through central apertures of the plastic bearings and is supported for rotation therein. The annular magnetic flange is positioned within an annular channel formed between the axially extending pole pieces and the radially extending pole pieces.

In a more particular embodiment, the normal position is a position wherein the valve member is closed.

In a further embodiment, the gear assembly includes at least three reducing stages that reduce the output speed of the motor. The gear assembly may have between a 100:1 and 200:1 gear reduction. Further, a return spring, in one embodiment, is operably coupled to the gear assembly downstream from the motor by at least three reducing gear stages such that additional friction at the motor is magnified through the gear assembly.

In some embodiments, the motor must be energized to maintain the valve in the non-normal actuated position.

A valve actuator having a synchronous motor, a coupling, a gear assembly and return spring is provided. The synchronous motor provides rotational motion. The coupling is configured to operably rotationally couple the motor to a valve stem of a valve. The motor, when energized, operably drives the coupling from a normal state to a non-normal actuated state. The gear assembly is operably coupled between the motor and the coupling to transfer the rotational output of the synchronous motor to the coupling. The return spring is operably coupled to the gear assembly and is configured to bias the coupling from the non-normal actuated state to the normal state when the synchronous motor is de-energized.

The synchronous motor also includes a magnetic coil for generating alternating magnetic flux. The motor includes a stator arrangement including a magnetic hub surrounded by the magnetic coil. The stator arrangement also includes an upper disc and a lower disc attached proximate a first end of the magnetic hub. The upper disc includes upper radially extending pole pieces and the lower disc includes lower radially extending pole pieces. The upper and lower radially extending pole pieces alternating angularly. An undulating shielding disc is interposed between adjacent upper and lower radially extending pole pieces. The undulating shielding disc passes above the lower radially extending pole pieces and below the upper radially extending pole pieces shading the upper pole pieces. The stator includes a set of shielded and set of unshielded axially extending pole pieces and an undulating shielding ring interposed between adjacent ones of the shielded and unshielded pole pieces such that the shielding ring passes over a radially outer surface of the unshielded axially extending pole pieces and radially inward of a radially inner surface of the shielded axially extending pole pieces. The synchronous motor further includes a rotor including a rotor shaft coupled to an annular magnetic flange. The magnetic hub includes a pair of plastic bearings mounted therein to reduce corrosion effects due to fretting corrosion when the motor is in a stalled state. The rotor shaft passes through central apertures of the plastic bearings and is supported for rotation therein. The annular magnetic flange is positioned within an annular channel formed between the axially extending pole pieces and the radially extending pole pieces.

In a more particular embodiment, the gear assembly includes at least three reducing stages that reduce the output speed of the motor. In a further embodiment, the return spring is operably coupled to the gear assembly downstream from the motor by at least three reducing gear stages. And an even further embodiment, The gear assembly between the motor and the coupling has a overall gear ratio of between about 100:1 and 200:1.

In a further embodiment of a valve actuator (or valve arrangement using this valve actuator), a valve actuator includes a synchronous motor, a coupling, a gear assembly and a spring return. The synchronous motor provides rotational motion. The coupling is configured to operably rotationally couple the motor to a valve stem of a valve. The motor, when energized, operably drives the coupling from a normal state to a non-normal actuated state. The gear assembly operably couples the motor and the coupling to transfer the rotational output of the synchronous motor to the coupling. The return spring operably couples to the gear assembly and is configured to bias the coupling from the non-normal actuated state to the normal state when the synchronous motor is de-energized (i.e. not energized). the motor includes a magnetic coil, a rotor and a stator arrangement or assembly. The magnetic coil generates an alternating magnetic flux when coupled to an alternating current. The rotor is driven by the magnetic flux. The rotor includes a rotor shaft coupled to an annular magnetic flange that interacts with the magnetic flux to rotate the rotor. The stator arrangement includes a magnetic hub surrounded by the magnetic coil. The magnetic hub has at least two plastic bearings mounted therein. The rotor shaft is rotationally supported by the plastic bearings. The stator arrangement includes upper radially extending pole pieces and a plurality of axially extending pole pieces, spaced radially outward in a cylindrical pattern from the ends of the radially extending pole pieces. The pole pieces (axially extending and radially extending) are operably coupled to the magnetic hub such that the magnetic flux generated by the magnetic coil travel through the stator. The annular magnetic flange of the rotor is positioned within an annular channel formed between the axially extending pole pieces and the ends of the radially extending pole pieces. In a preferred embodiment, the plastic bearings have a coefficient of friction of less than 0.2 and more preferably less than 0.15 and more preferably below 0.125 and a deflection temperature of at least 200 degrees Fahrenheit, more preferably at least 225 degrees Fahrenheit, more preferably at least 250 degrees Fahrenheit.

In a further embodiment, a synchronous motor is provided. The synchronous motor includes a magnetic coil, a rotor and a stator. The magnetic coil generates alternating magnetic flux when energized by an alternating current. The rotor is driven by the magnetic flux. The rotor including a rotor shaft coupled to an annular magnetic flange. The stator helps define the path of the magnetic flux. The stator arrangement includes a magnetic hub surrounded by the magnetic coil. The stator arrangement includes an upper disc and a lower disc attached proximate a first end of the magnetic hub. The upper disc includes upper radially extending pole pieces and a the lower disc including lower radially extending pole pieces. The upper and lower radially extending pole pieces alternate angularly. An undulating shielding disc is interposed between adjacent upper and lower pole pieces. The undulating shielding disc passes axially above the lower radially extending pole pieces and axially below the upper radially extending pole pieces shading the upper radially extending pole pieces. The stator includes a set of shielded and set of unshielded axially extending pole pieces. An undulating shielding ring is interposed between adjacent ones of the shielded and unshielded axially extending pole pieces. The shielding ring passes over a radially outer surface of the unshielded axially extending pole pieces and radially inward of a radially inner surface of the shielded axially extending pole pieces. The magnetic hub includes a pair of plastic bearings mounted therein. The rotor shaft passes through central apertures of the plastic bearings and is supported for rotation therein. The annular magnetic flange is positioned within an annular channel formed between the axially extending pole pieces and the radially extending pole pieces.

In a preferred embodiment, the material of the bearings supporting the shaft is non-metallic and is more compliant than standard babbit bearings. As such, the bearings will become compliant and polish relative to the shaft such that the bearings will not wipe away the oxide formed on the rotor shaft.

In a more particular embodiment, the bearings are formed from a plastic material. In a more preferred embodiment, the plastic material is considered low friction, which will include plastics having a coefficient of friction of below 0.2 and more preferably below 0.15 and more preferably below 0.125. Further plastic material will be considered to have high strength at high temperatures such that the plastic can withstand the temperature presented by the synchronous motor's inefficiency. Such a plastic having high strength at high temperature should have a deflection temperature of at least 200 degrees Fahrenheit and more preferably at least 225 degrees Fahrenheit and more preferably at least 260 degrees Fahrenheit. Notably, most plastic materials with higher deflection temperatures have higher coefficients of friction. However, additives can be added to reduce the coefficient of friction for higher deflection temperature plastics.

In a further synchronous motor, the motor includes a magnetic coil, a rotor and a stator arrangement or assembly. The magnetic coil generates an alternating magnetic flux when coupled to an alternating current. The rotor is driven by the magnetic flux. The rotor includes a rotor shaft coupled to an annular magnetic flange that interacts with the magnetic flux to rotate the rotor. The stator arrangement includes a magnetic hub surrounded by the magnetic coil. The magnetic hub has at least two plastic bearings mounted therein. The rotor shaft is rotationally supported by the plastic bearings. The stator arrangement includes upper radially extending pole pieces and a plurality of axially extending pole pieces, spaced radially outward in a cylindrical pattern from the ends of the radially extending pole pieces. The pole pieces (axially extending and radially extending) are operably coupled to the magnetic hub such that the magnetic flux generated by the magnetic coil travel through the stator. The annular magnetic flange of the rotor is positioned within an annular channel formed between the axially extending pole pieces and the ends of the radially extending pole pieces. In a preferred embodiment, the plastic bearings have a coefficient of friction of less than 0.15 and more preferably less than 0.125 and a deflection temperature of at least 200 degrees Fahrenheit, more preferably at least 225 degrees Fahrenheit, more preferably at least 250 degrees Fahrenheit.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view illustrating a valve actuator and a valve body constructed according to the invention;

FIG. 2 is an exploded isometric view of the valve actuator and valve body of FIG. 1;

FIG. 3 is an exploded isometric view showing the internal components of the valve actuator of FIG. 2 for providing normally closed operation of the valve body;

FIG. 4 is an exploded isometric view with a portion of the valve body broken away to show its internal components and with certain of the components of the valve actuator removed;

FIG. 5 is a top plan view of the components of the valve actuator of FIG. 4, with reference to line 5-5 of FIG. 6, showing the position of the valve actuator components when the valve member of the valve body is in its closed position;

FIG. 6 is a section view taken along line 6-6 of FIG. 5;

FIG. 7 is a section view taken along line 7-7 of FIG. 6, showing the valve member in its closed position;

FIG. 8 is a view similar to FIG. 5, showing movement of the valve components so as to move the valve member away from its closed position of FIG. 7;

FIG. 9 is a view similar to FIG. 7 showing movement of the valve member to its open position upon movement of the valve actuator components to the position as shown in FIG. 8;

FIG. 10 is a view similar to FIGS. 5 and 8, showing the valve actuator components when manually locked in an open position;

FIG. 11 is a section view taken along line 11-11 of FIG. 10;

FIG. 12 is a section view taken along line 12-12 of FIG. 10;

FIG. 13 is a view similar to FIGS. 7 and 9 showing the position of the valve member when the components of the valve actuator are in their FIG. 10 position;

FIG. 14 is an isometric illustration of the motor assembly of the valve actuator of FIG. 1;

FIG. 15 is an exploded illustration of the motor of FIG. 14;

FIG. 16 is a cross-sectional illustration of the motor of FIG. 14;

FIG. 17 is a partial isometric illustration of a representative stator assembly of the motor of FIG. 14;

FIG. 18 is an exploded cross-sectional illustration of the rotor and the bearings and hub that support the rotor of the motor of FIG. 14; and

FIG. 19 is a simplified schematic representation of the power transmission structures of the valve actuator and valve assembly of FIG. 1 showing the various gear stages between the motor and the valve member.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The present invention relates to improvements in valves that utilize electrical actuators, such as disclosed in U.S. Pat. No. 6,073,907, to the assignee of the instant application. An introduction of the operation of those valves will be provided first and then a discussion of the motor used within the actuators thereof will be provided.

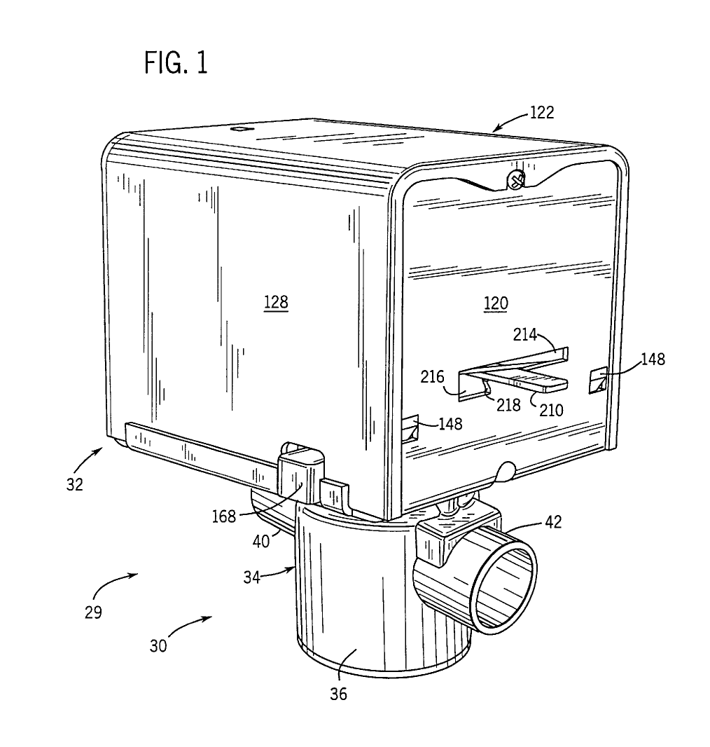

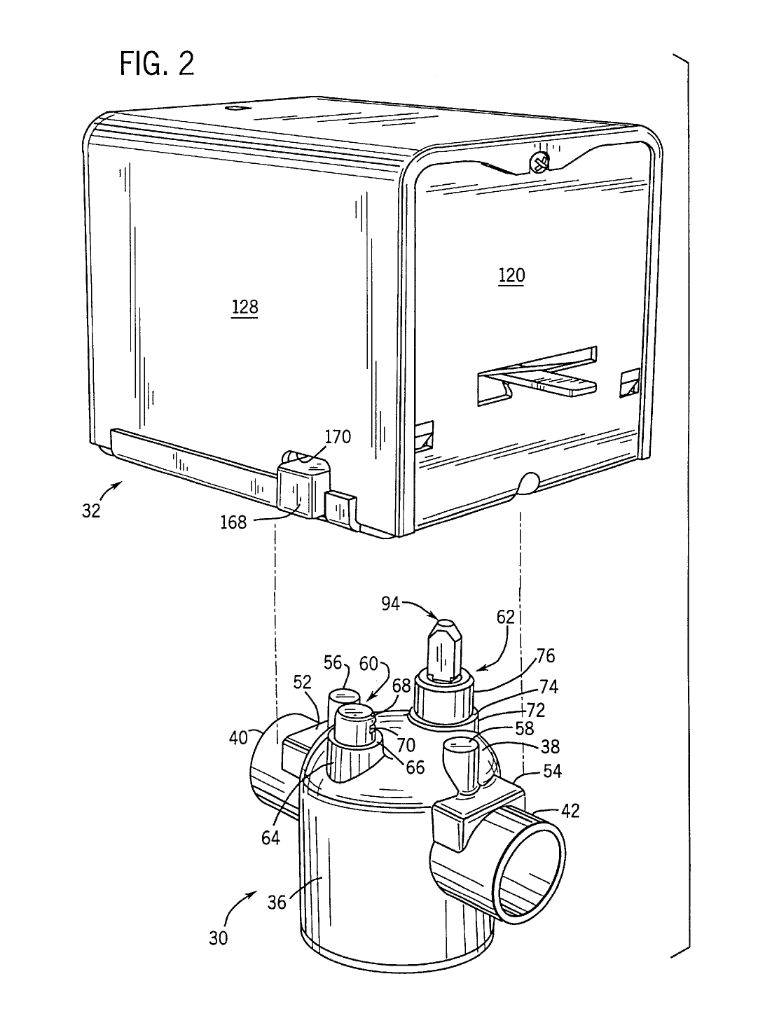

With that introduction, FIG. 1 illustrates a valve assembly 29 including a valve body 30 and a valve actuator assembly 32. Valve body 30 includes a central body portion 34 defined by a peripheral sidewall 36 and a domed upper wall 38 (FIG. 2). A pair of nipples 40, 42 extend from sidewall 36. Nipples 40, 42 are adapted to be plumbed into a fluid flow line, such as a line used in a water-operated heating system or in any other application requiring regulation of fluid flow in the line.

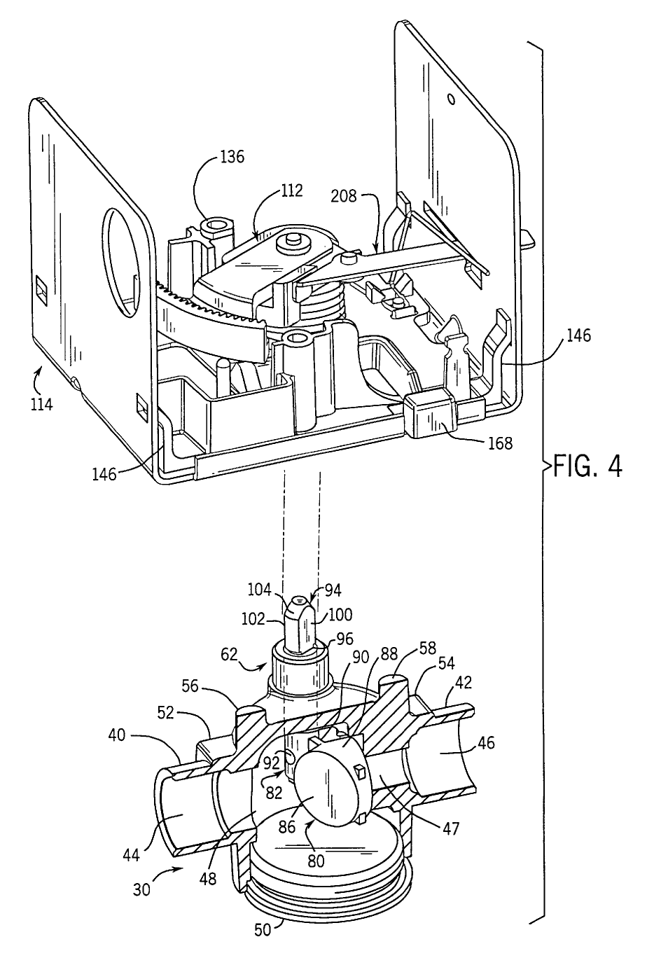

As shown in FIG. 4, nipple 40 defines an outlet passage 44 and nipple 42 defines an inlet passage 46 having an inner restricted portion 47. Passages 44 and 46 communicate with each other through a cavity 48 formed in central valve body portion 34, which is defined by sidewall 36 and domed upper wall 38 in combination with a plug 50 which closes the lower end of central body portion 34 and is secured to the lower extent of sidewall 36.

Referring to FIGS. 4 and 6, a valve member 80 is disposed within cavity 48. Valve member 80 is connected to an operating member such as a valve stem 82 which is pivotably received within passage 78 (FIG. 6). Valve member 80 defines a sealing surface 84, and an outer side surface 88 and 86 extending therebetween.

The upper end of valve stem 82 defines a connector portion 94 (FIG. 4). Connector portion 94 defines a pair of oppositely facing parallel flat side surfaces 100, 102 and a conical upper end 104 for transmitting torque from the actuator assembly to the valve stem 82.

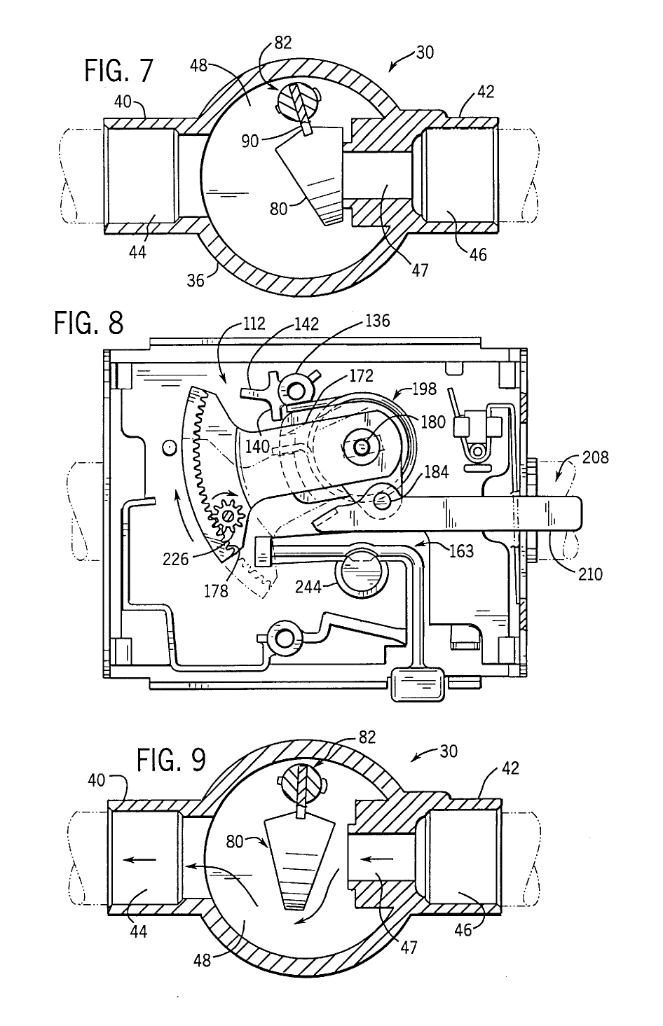

The pivotable mounting of valve stem 82 to valve body 34 provides movement of valve member 80 between a closed position as shown in FIGS. 4, 6 and 7 and an open position as shown in FIG. 9. In its closed position, valve member 80 functions to cut off communication between valve cavity 48 and nipple passage 46 to prevent flow of fluid therebetween.

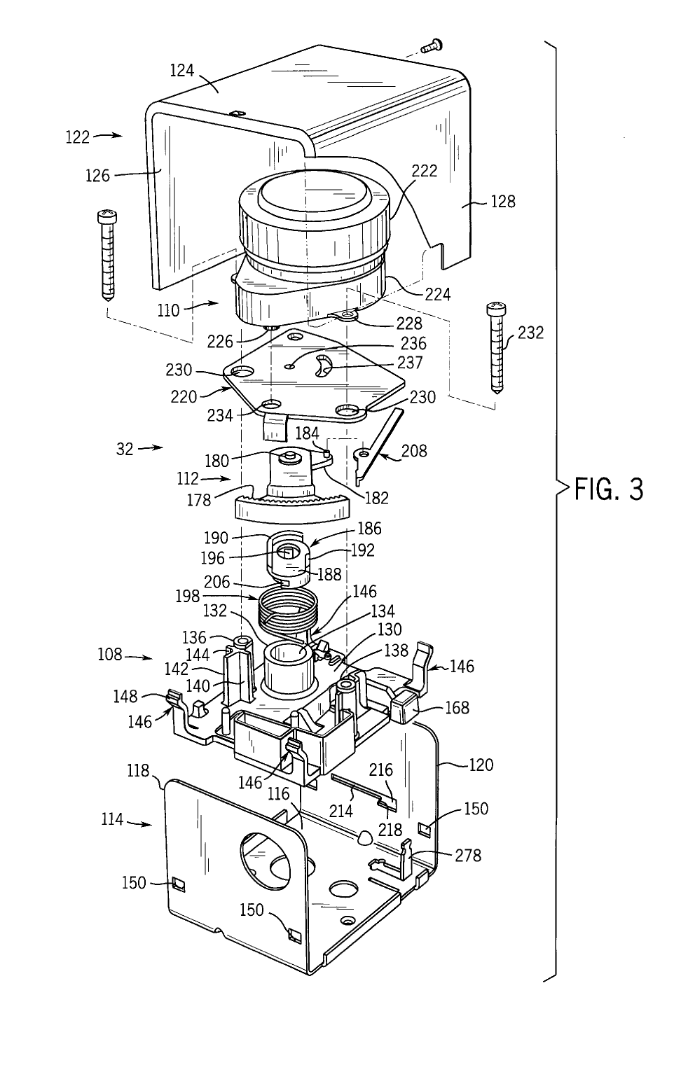

Referring to FIG. 3, valve actuator assembly 32 generally includes an adaptor plate 108, a motor 110 and a drive gear 112. In a manner to be explained, drive gear 112 is mounted to adaptor plate 108 for pivoting movement, and motor 110 is likewise mounted to adaptor plate 108 and is drivingly engaged with drive gear 112, which in turn is engaged with valve stem 82 for providing movement of valve member 80 between its open and closed positions.

Actuator assembly 32 includes a housing enclosure having a lower section 114 including a bottom wall 116 and a pair of sidewalls 118, 120 extending upwardly from the opposite ends of bottom wall 116. The housing enclosure further includes an upper section 122 defining an upper wall 124 and a pair of sidewalls 126, 128 extending downwardly from opposite ends of upper wall 124. In this manner, lower section 114 defines an upwardly open U-shape and upper section 122 defines a downwardly open U-shape which fit together such that sidewalls 118, 120 of lower section 114 are received within the space between sidewalls 126, 128 of upper section 122. Similarly, sidewalls 126, 128 of upper section 122 are received within the space between sidewalls 118, 120 of lower section 114, to define a housing having an interior for receiving the operating components of actuator assembly 32.

A series of spring clips 146 mount adaptor plate 108 to housing lower section 114 in a snap-on manner between sidewalls 118, 120 of housing lower section 114 with tabs 148 snap engaged into openings 150.

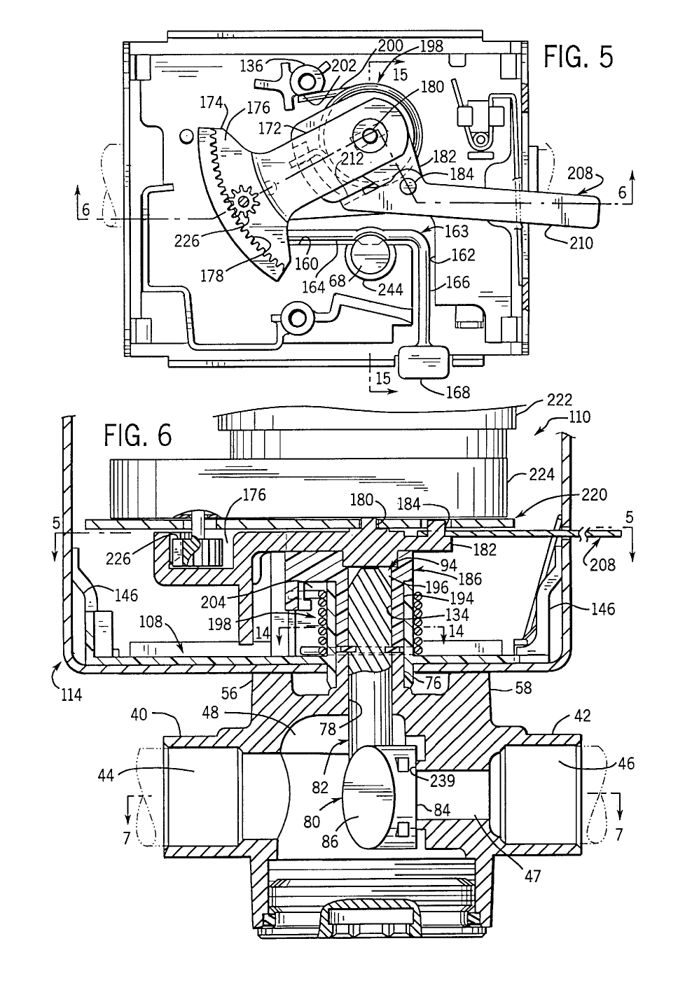

Referring to FIGS. 4 and 5, an engagement member is formed integrally with base plate 130, and is in the form of a latch arm 163 having an inner section 164 and an outer section 166 which extends at a right angle relative to inner section 164. An engagement button 168 is formed at the outer end of latch arm outer section 166. Engagement button 168 extends outwardly past the adjacent side edge of adaptor plate 108, and extends through an opening 170 (FIG. 2) formed in sidewall 128 of housing upper section 122.

Referring to FIGS. 3, 5 and 6, drive gear 112 is in the form of a sector gear defining an arm 172 interconnected with an outer section 174 having a channel 176 formed therein (however, other gears could be used). A series of inwardly facing gear teeth 178 are formed in outer section 174 on a wall defining channel 176, and gear teeth 178 are arranged in an arcuate configuration having a center coincident with a pivot axis of drive gear 112 defined by a stud 180 mounted to the inner end of arm 172.

A gear bearing 186 is interposed between drive gear arm 172 and cylindrical member 132 which extends upwardly from base plate 130. Gear bearing 186 defines an upper surface 188 which receives a downwardly facing surface defined by drive gear arm 172. A J-shaped wall 190 extends upwardly from the side edge of bearing 186 above upper surface 188, and a short wall section 192 extends upwardly from the opposite side of gear bearing 186. With this construction, drive gear arm 172 is nested within the space defined between walls 190 and 192, such that tab 182 extends outwardly through the space between walls 192 and 190, as does drive gear outer section 174.

As shown in FIG. 6, gear bearing 186 includes a downwardly extending mounting member 194 having a vertical slot 196 formed therein. Mounting member 194 has a circular cross-section slightly smaller than the diameter of passage 134 defined by upstanding cylindrical member 132. In this manner, mounting member 194 is received within passage 134 so as to pivotably mount gear bearing 186 to cylindrical member 132 and thereby to adaptor plate 108. This in turn functions to pivotably mount drive gear 112 to adaptor plate 108.

A torsion spring 198 surrounds cylindrical member 132, defining an internal diameter slightly larger than the external diameter of cylindrical member 132. As shown in FIG. 5, torsion spring 198 defines a lower end extension 200 which engages a flat surface 202 defined by mounting boss 136. Torsion spring 198 further defines an upper end extension 204 which is received within a slot 206 defined by gear bearing 186. Torsion spring 198 functions to bias drive gear 112 in a counterclockwise direction, for reasons which will later be explained.

Referring to FIGS. 3 and 5, a manually operated lever 208 is provided to position and lock the valve in the “non-normal state” in the event the user wishes to manually position the valve when the motor power is not energized. Lever 208 is pivotable about pin 184, and handle portion 210 of lever 208 extends through a slot 214 formed in sidewall 120 of housing lower section 114. Slot 214 includes an enlarged end 216 which defines an angled engagement surface 218 with which lever 208 can interact to hold the valve in a desired position when power has been lost.

A bearing plate 220 overlies drive gear 112, and motor assembly 110 is mounted to bearing plate 220. Motor assembly 110 generally includes a motor 222 having a motor output which is drivingly interconnected with a drive gear mechanism 224 including an output drive gear 226 (also referred to as pinion gear 226).

As shown in FIG. 5, drive gear 226 of motor assembly 110 engages drive gear 112 when motor assembly 110 and drive gear 112 are assembled. With this arrangement, operation of motor assembly 110 functions to impart pivoting movement to drive gear 112 via engagement of motor output drive gear 226 with drive gear teeth 178.

Motor 222 is preferably a unidirectional synchronous motor, and operation of motor 222 to rotate motor output drive gear 226 in a clockwise direction functions to move drive gear 112 in a clockwise direction against the biasing force exerted by torsion spring 198. However, the arrangement could be configured to operate in a counter-clockwise direction.

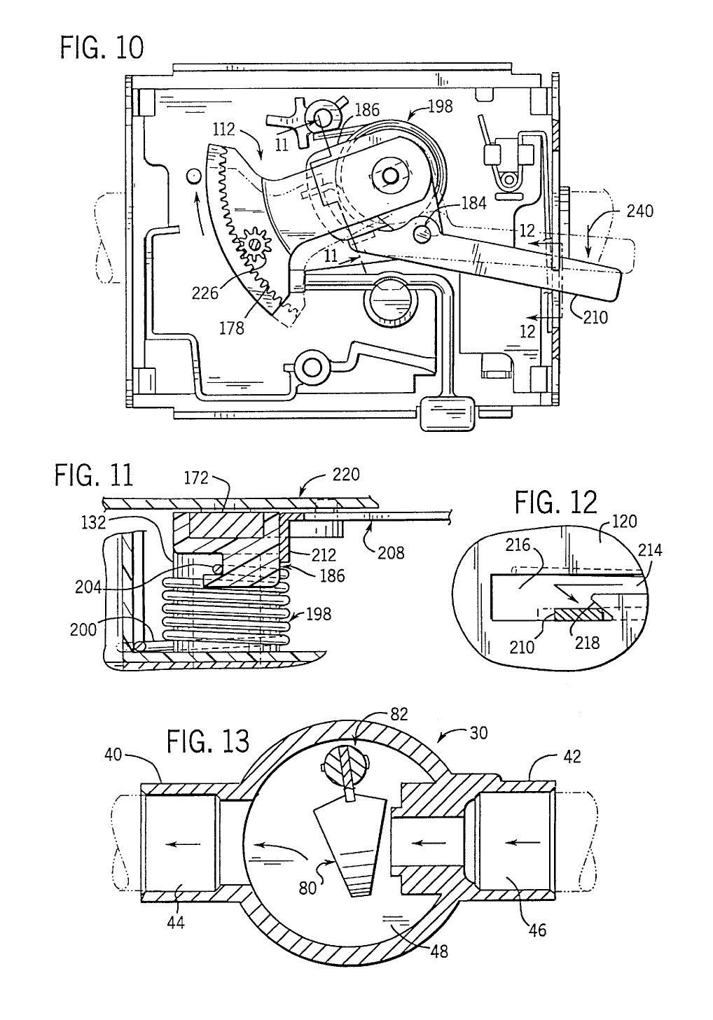

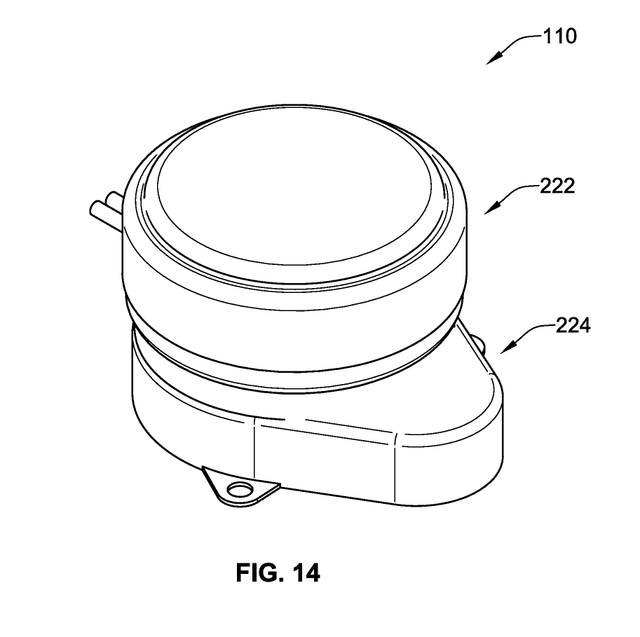

The components of valve assembly 30 as illustrated in FIGS. 1-11 and as described above provide normally closed operation of valve assembly 30. That is, when motor 222 is not being operated (i.e. not energized), spring 198 functions to move drive and/or bias gear 112 in a counter-clockwise direction, which movement is transferred through gear bearing 186 and valve stem connector portion 94 to valve stem 82 and thereby to valve member 80 for seating sealing surface 84 of valve member 80 against a peripheral seating surface, shown at 239, defined by valve body 30 at the inner end of restricted passage portion 47.

When it is desired to allow fluid to flow through valve body 34, motor 222 is energized so as to impart clockwise rotation to motor output drive gear 226 and to move drive gear 112 in a clockwise direction, as described previously and as shown in FIG. 8, for moving valve member 80 to its open position as shown in FIG. 9 in which sealing surface 84 of valve member 80 is moved away from valve seating surface 239 to establish communication between nipple passages 44 and 46.

In the event power to motor 222 is lost and it is desired to open valve assembly 30, a user manually engages handle portion 210 of lever 208 and moves handle portion 210 in a direction as shown at arrow 240 (FIG. 10). This movement of handle portion 210 functions to pivot lever 208 about pin 184 to bring engagement surface 212 of lever 208 into engagement with gear bearing 186, so as to pivot drive gear 112 in a clockwise direction as shown in FIG. 10. If desired, handle portion 210 can be moved into enlarged end 216 of slot 214 and into engagement with engagement surface 218 for maintaining valve member 80 in an open position as shown in FIG. 13.

As noted previously, FIG. 8 illustrates drive gear 112 being rotated in a clockwise direction toward a position in which valve member 80 is placed in its fully open position of FIG. 9. When drive gear 112 is fully rotated clockwise to position valve member 80 in its open position of FIG. 9, the edge of drive gear arm section 172 engages the end of rib 140 provided on boss 136. Rib 140 thus provides a mechanical stop for drive gear 112 to limit its rotation in response to operation of motor 222. At this point, the motor 222 will be stalled in a “non-normal state.” However, motor 222 is continuously energized so as to prevent spring 198 from returning it to its “normal state,” i.e. the closed position with the configuration of this valve.

Now that the general operation of the valve assembly 29 has been described the motor assembly 110 will be more fully described.

The motor 222 of the motor assembly 110 is a synchronous motor that generally operates on the principles discussed previously and in the U.S. Pat. Nos. 3,310,696; 2,256,711; 2,295,786; 2,283,363; 2,374,347; 2,450,955; and 2,305,963 to W. L. Hansen et al.

The use of a synchronous motor of this type allows the motor 222 to be stalled when the valve assembly 29 is fully transitioned to the non-normal state to hold the valve assembly 29 in that orientation for an extended period of time (e.g. 3 months). Other types of motors, such a DC motors, cannot typically be stalled as they would create too much heat causing the motor to burn up or otherwise fail.

Synchronous motors of this type are typically considered to be inefficient motors that may operate at as little as 30% efficiency such that only 30% of the power that is put into the motor 222 is returned in mechanical powers, such as horsepower.

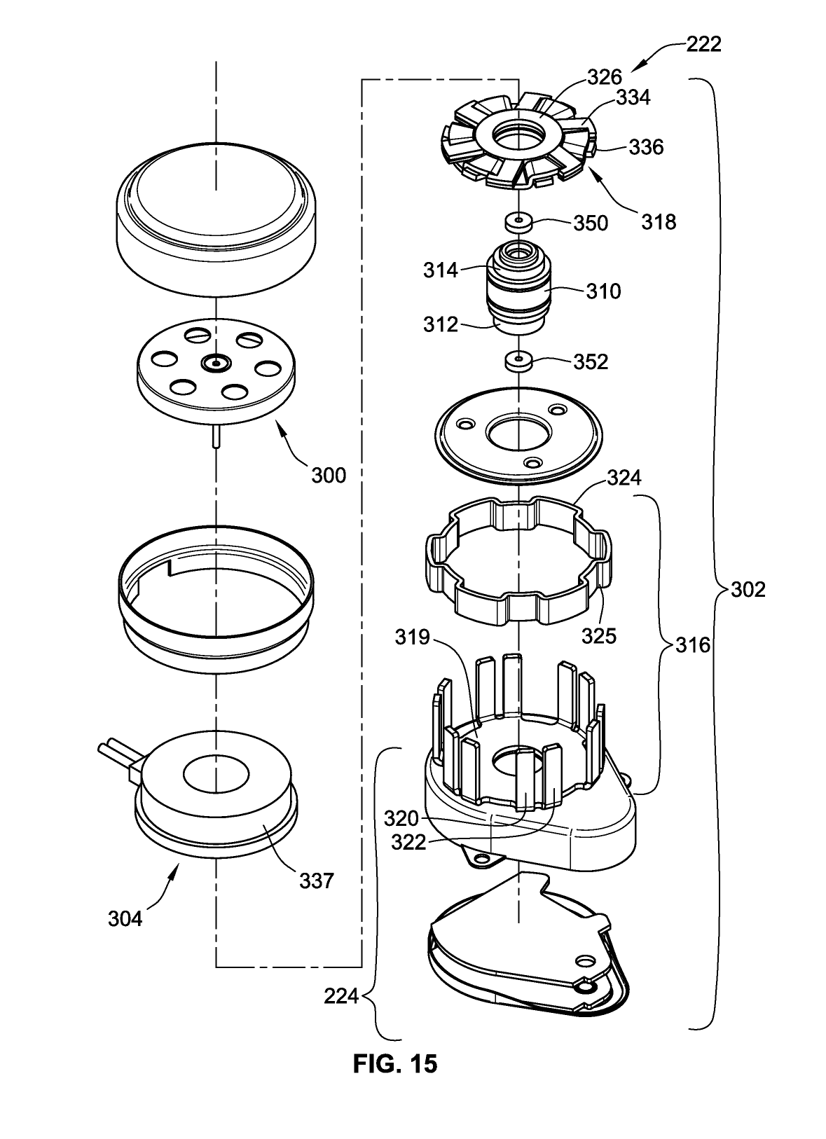

With reference to FIG. 15, the motor 222 generally operates on alternating current. The motor 222 generally includes a rotor 300, a stator 302 and a magnetic coil 304 that generates a magnetic flux that passes through the stator 302 and that interacts with rotor 300 to cause rotor 300 to rotate.

With reference to FIGS. 15-17, the stator 302 includes a magnetic tubular hub 310 that includes reduced diameter portions 312, 314 upon which are mounted outer and inner field pole assemblies 316, 318.

The outer field pole assembly consists of a disc 319 having an aperture by which it is mounted on to portion 312 of the hub 310. Disc 319 includes axially extending pole pieces 320, 322 disposed alternately in a cylindrical path about the hub 310. The pole pieces 320, 322 are preferably not equi-distantly spaced about the disc 319, but instead are arranged in pairs around the periphery of the disc 319. The alternating pole pieces 322 are shaded by an undulating ring 324 of non-magnetic material, such as copper. This ring 324 passes over the outer surfaces of the pole pieces 320 and therefore does not shade pole pieces 320. The shading ring 324 is provided with undulating portions 325 passing around three sides of the pole pieces 322 (including the radially inward surface and two adjacent sides), thereby shading these pole pieces 322 providing a phase lag when the field structure is magnetized by an alternating flux provided by magnetic coil 304.

The inner field pole assembly 318 consists of a pair of generally star-shaped discs 326, 328, having apertures 330, 332 by which they are mounted on to portion 314 of hub 310. Disc 326 is provided with pole pieces 334 that extend radially outward from a central hub region in a spoked fashion. Typically, the pole pieces 334 extend radially outwardly, and are so positioned that a center line drawn through each pole piece 334 will run parallel with a center line drawn through the directly opposite pole piece 334. Due to this arrangement, they do not extend truly radially, but will be considered as extending radially outward. The pole pieces 334 are bent slightly downwardly at their tips to give, in general, a dished appearance. The tips may be hook shaped at the end (not shown). Further, disc 326 may be provided by more than one disc stacked on top of one another.

The lower disc 328 has similarly outwardly extending pole pieces 336, which as in the case of the upper disc 326, do not have a strictly radial direction. The tips of pole pieces 336 are preferably bent radially upward. Pole pieces 336 are typically narrower than pole pieces 334 and are generally straight without a hooked end.

In addition to discs 326, 328 an undulating shading ring 340, preferably of a non-magnetic metal such as copper, is provided between the upper and lower discs 326, 328. The position of the undulations of the shading ring 340 are such that the upwardly extending portions are positioned directly over the narrow pole pieces 336 when the motor 222 is assembled and the downwardly extending pieces portions are adapted to receive the wide upper pole pieces 334. Shading ring 340 shades upper pole pieces 334 while it does not shade lower pole pieces 336. This shading ring 340 introduces a similar shading effect or phase lag as shading ring 324 for the vertical pole pieces 320, 322.

The field structure formed by the radial pole pieces 334, 336 and the axial pole pieces 320, 322 is magnetized by magnetic coil 304 wound on a drum or spool 337 of insulating material and contained within a plastic housing 337. The magnetic coil 304 is mounted to hub 310. Leads connect on opposite sides of coil 310 and are adapted to be connected to a suitable source of alternating current to generate alternating magnetic flux.

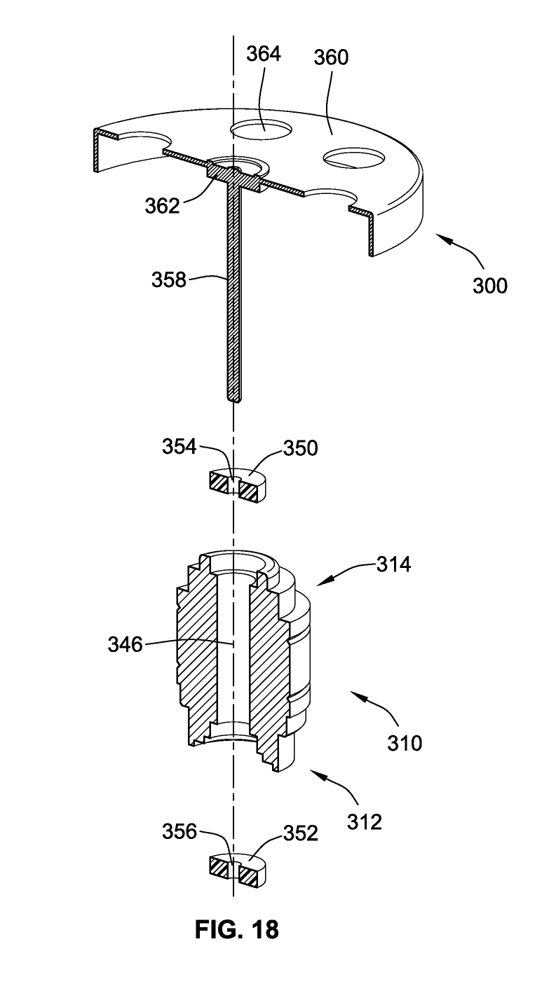

With reference to FIG. 18, the magnetic hub 310 includes an axial bore 346 that carries plastic or nylon bearings in the form of washers 350, 352 in counter bores formed at opposed ends of the hub 310. The washers 350, 352 have center openings 354, 356 that receive the rotor shaft 358 of rotor 300.

The plastic used for these washers or bearings is preferably low friction such that it has a coefficient of friction between itself and shaft of about 0.1 and 0.15 and more preferably no more than 0.125. Further, the plastic material has high strength at high temperatures, which can be measured by having a deflection temperature of at least deflection temperature of at least 200 degrees Fahrenheit, more preferably at least 225 degrees Fahrenheit, more preferably at least 250 degrees Fahrenheit. The low coefficient of friction reduces the sticking when grease or other lubricants are no longer or not present between the shaft 358 and bearings 350, 352, as opposed to prior art uses of metallic bearings, and more particularly metallic babbitt bearings. This is because sintered Bronze on stainless or steel materials typically has a lubricated coefficient of friction of approximately 0.13, however when the interface is unlubricated the coefficient of friction jumps to approximately 0.35. As noted previously, one of the significant problems is that during the fretting action, the microscopic rotational movement is so minimal that lubricant is not drawn between the bearings and the rotor shafts. Thus, frictional forces can spike significantly increasing the load that must be overcome by the return spring when attempting to return the system to the normal state. Plastic materials provide the benefit of maintaining a low coefficient of friction without lubrication. Typically, the coefficient of friction for plastics does not change in an unlubricated state.

The bearings 350, 352 are preferably the bearings 350, 352 are highly compliant such that they polish rather than continuously polish the rotor shaft 358. As such, the oxide layer formed on the rotor shaft 358 remains on the rotor shaft 358 during fretting rather than being wiped away.

The use of the plastic or nylon to form washers 350, 352 provides a significant advantage over prior art systems, as will be more fully described below.

The rotor 300 includes a rotating disc 360 that is operably coupled to rotor shaft 358 by hub 362. The rotating disc 360 preferably includes equi-distantly spaced openings 364 and is formed of aluminum to reduce weight of the metal. The hub 362 preferably has a downwardly extending shoulder 366 that bears against washer 350.

The rotating disc 360 terminates in a peripheral rotor flange 368 formed from a cylindrical band of magnetic material such as hardened steel. The rotor flange 368 may be continuous or a strip of magnetic steel. Various types of rotors and rotor flanges may be used. The rotor flange 368 is radially thin and axially wide. The rotor flange 368 should be axially wider than the thickness of pole pieces 334, 336 so as to completely extend over the entire area presented by the pole tips of the radially projecting pole pieces 334, 336.

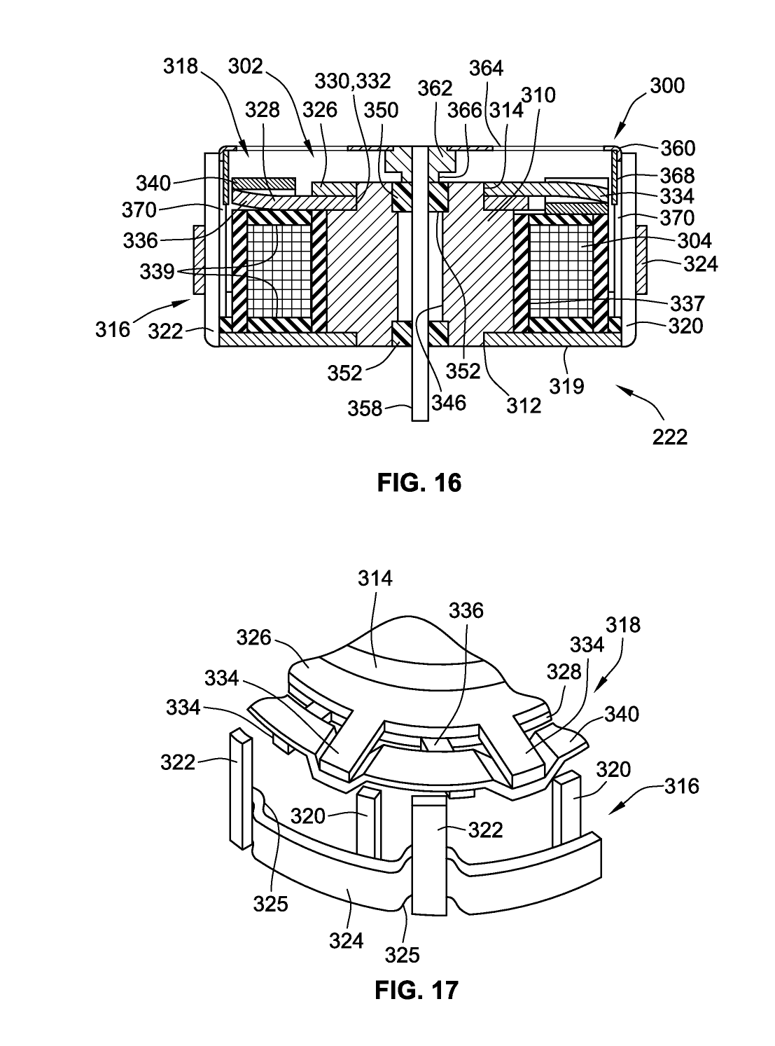

Further, with reference to FIG. 16, the axially projecting pole pieces 320, 322 extend axially above pole pieces 334. 336. Further, the radially extending pole pieces 334, 336 do not extend radially entirely to the axially extending pole pieces 320, 322 so as to form an annular space 370 therebetween which receives rotor flange 368.

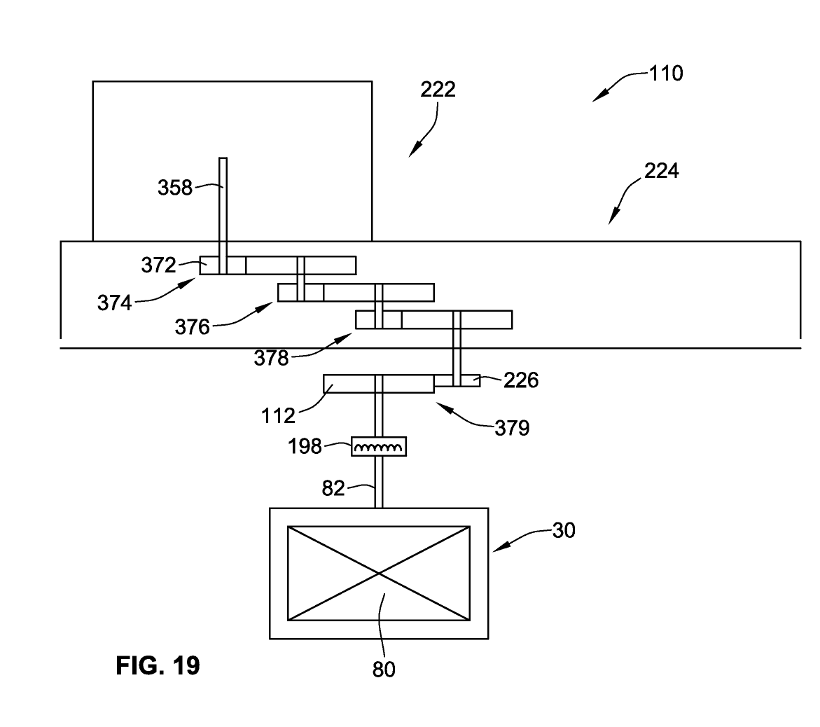

Motor 222 is generally a high-speed, low-torque motor. Thus, with additional reference to the simplified schematic of FIG. 19, the gear assembly provided by drive gear mechanism 224 and drive gear 226 and driven gear 112 between the motor 222 and the valve member 80 generally includes a plurality of stages 374, 376, 378, 379 to provide increased torque and reduced speed from the motor 222 to the valve member 80. There are three stages 375, 376, 378 provided within drive gear mechanism 224. A fourth stage 379 is external to the drive gear mechanism 224 and is provided between pinion gear 226 and gear 112.

A typical motor 222 operating at 60 Hz (cycles per second), such as U.S. line power frequency, will operate at 600 RPM (revolutions per minute). Further, such a motor will typically be rated at between 4 and 6 watts of power. The typical gear ratio provided by the drive gear mechanism is between about 100:1 and 200:1 and more preferably between about 125:1 and 175:1 and more preferably about 150:1 such that the resultant RPM of the pinion gear 226 is between about 3 and 6 RPM.

There is also a further reduction at stage 379 between pinion 226 and gear 112. Typically, this additional stage 379 is a 10:1 ration further reducing speed such that typical speeds at which the valve member 80 are driven by stem 82 is between about 0.3 and 0.6 RPM.

However, if this system operates on 50 Hz power, such as European Line power, the motor speed will typically operate at approximately 500 RPM, with corresponding RPM reductions through the gear assembly.

It is notable that torsion spring 198 is downstream of all four stages 374, 376, 378, 379 so that the motor 222 can overcome the torque provided thereby. However, due to the arrangement of the stages 374, 376, 378, 379 being speed reducing stages when viewed downstream from the motor 222 to the valve stem 82, when viewed in the opposite direction, upstream, e.g. toward motor 222 the stages 374, 376, 378, 379 act as torque-reducing and speed-increasing. Thus, when the system is being operated by spring 198, any load applied to the system upstream of the various stages 374, 376, 378, 379 is amplified in a similar manner making it harder for spring 198 to return the valve assembly to its normal state, i.e. a closed state for the illustrated embodiment.

While this embodiment uses four gear stages 374, 376, 378, 379, other embodiments might use more or less stages, but typically there will be at least three stages.

Not only do the various stages 374, 376, 378, 379 amplify any frictional resistance within the gear assembly upstream of torsion spring 198, the numerous gear stages and gears provided thereby provide for microscopic slop and flexure within the system. As such, slight rotations that are input at either the motor end or the drive gear 112 end of the gear assembly are typically not seen at the opposite end. Thus, slight microscopic rotational vibrations at pinion gear 372 attached to rotor shaft 358 are typically not translated at all to driven gear 112.

The current assembly of the aforementioned actuator assembly in combination with the valve and when used in HVAC or refrigeration systems where the valve member 80 may be maintained in the non-normal state (i.e. open in the instant embodiment) for prolonged periods of time (i.e. 3-9 months) creates significant problems in prior art designs.

As noted, the prior art designs utilized metal bearings, typically babbit bearings, to support rotor shaft 358. However, over time, these devices were found to tend to stick in the non-normal state such that spring 198 could not return the assembly to the normal state (again, the closed position for the illustrated embodiment).

As noted previously, the Applicant determined that a significant problem causing this sticking was due to formation of oxides between the rotor shaft and the previous metal bearings. This oxide increased the frictional interaction between the rotor shaft and the bearings. This increased friction was magnified during attempts by the spring to return the actuator to the normal state due to the significant gear reduction provided by the particular gear train necessary to convert the high speed low torque output of the synchronous motor to a high enough torque to drive the valve member and the return springs.

The inclusion of the plastic bearings 350, 352 has reduces the friction problem between the bearings 350, 352 and the rotor shaft 358.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A valve comprising:
a valve assembly including a valve member moveable between open and closed positions;
a valve actuator operably coupled to the valve member to drive the valve member between the open and closed positions, the valve actuator having a default normal position corresponding to one of the open and closed positions and a non-normal actuated position corresponding to the other one of the closed and open positions, the valve actuator including:
a synchronous motor for driving the valve member and a gear assembly operably coupled between the motor and the valve member to transfer the rotational output of the synchronous motor to the valve member; and
the synchronous motor including a magnetic coil for generating alternating magnetic flux; a stator arrangement including a magnetic hub surrounded by the magnetic coil, the stator arrangement including an upper disc and a lower disc attached proximate a first end of the magnetic hub, the upper disc including upper radially extending pole pieces and a the lower disc including lower radially extending pole pieces, the upper and lower pole pieces alternating angularly, an undulating shielding disc is interposed between adjacent upper and lower pole pieces, the undulating shielding disc passes above the lower pole pieces and below the upper pole pieces shading the upper pole pieces, the stator including a set of shield and set of unshielded pole pieces and an undulating shielding ring interposed between adjacent ones of the shielded and unshielded pole pieces such that the shielding ring passes over a radially outer surface of the unshielded pole pieces and radially inward of a radially inner surface of the shielded pole pieces; the synchronous motor further including a rotor including a rotor shaft coupled to an annular magnetic flange, the magnetic hub including a pair of plastic bearings mounted therein, the rotor shaft passing through central apertures of the plastic bearings and being supported for rotation therein, the annular magnetic flange being positioned within an annular channel formed between the axially extending pole pieces and the radially extending pole pieces.

2. The valve of claim 1, wherein the normal position is a position wherein the valve member is closed.

3. The valve of claim 1, wherein the gear assembly includes at least three reducing stages that reduce the output speed of the motor.

4. The valve of claim 3, further comprising a return spring operably coupled to the gear assembly downstream from the motor by at least three reducing gear stages.

5. The valve of claim 4, wherein in the non-normal actuated position, the electric motor is continuously energized in a stalled state to maintain the valve assembly in the non-normal actuated position.

6. The valve of claim 5, wherein the gear assembly between the motor and the coupling has a gear ratio of between about 100:1 and 200:1.

7. The valve of claim 1, wherein the plastic bearings have a coefficient of friction of less than 0.15.

8. The valve of claim 1, wherein the plastic bearings have a deflection temperature of at least 200 degrees Fahrenheit.

9. A valve actuator comprising:
a synchronous motor for providing rotational motion;
a coupling configured to operably rotationally couple the motor to a valve stem of a valve, the motor, when energized, operably driving the coupling from a normal state to a non-normal actuated state;
a gear assembly operably coupled between the motor and the coupling to transfer the rotational output of the synchronous motor to the coupling;
a return spring operably coupled to the gear assembly configured to bias the coupling from the non-normal actuated state to the normal state when the synchronous motor is de-energized; and
the synchronous motor including a magnetic coil for generating alternating magnetic flux; a stator arrangement including a magnetic hub surrounded by the magnetic coil, the stator arrangement including an upper disc and a lower disc attached proximate a first end of the magnetic hub, the upper disc including upper radially extending pole pieces and a the lower disc including lower radially extending pole pieces, the upper and lower pole pieces alternating angularly, an undulating shielding disc is interposed between adjacent upper and lower pole pieces, the undulating shielding disc passes above the lower pole pieces and below the upper pole pieces shading the upper pole pieces, the stator including a set of shielded and set of unshielded axially extending pole pieces and an undulating shielding ring interposed between adjacent ones of the shielded and unshielded axially extending pole pieces such that the shielding ring passes over a radially outer surface of the unshielded pole pieces and radially inward of a radially inner surface of the shielded pole pieces; the synchronous motor further including a rotor including a rotor shaft coupled to an annular magnetic flange, the magnetic hub including a pair of plastic bearings mounted therein, the rotor shaft passing through central apertures of the plastic bearings and being supported for rotation therein, the annular magnetic flange being positioned within an annular channel formed between the axially extending pole pieces and the radially extending pole pieces.

10. The valve actuator of claim 9, wherein the gear assembly includes at least three reducing stages that reduce the output speed of the motor.

11. The valve actuator of claim 10, wherein the return spring is operably coupled to the gear assembly downstream from the motor by at least three reducing gear stages.

12. The valve actuator of claim 11, wherein the gear assembly between the motor and the coupling has a gear ratio of between about 100:1 and 200:1.

13. The valve actuator of claim 9, wherein the plastic bearings have a coefficient of friction of less than 0.15.

14. The valve actuator of claim 9, wherein the plastic bearings have a deflection temperature of at least 200 degrees Fahrenheit.

15. A synchronous motor including:
a magnetic coil for generating alternating magnetic flux;
a rotor driven by the magnetic flux, the rotor including a rotor shaft coupled to an annular magnetic flange, and
a stator arrangement including a magnetic hub surrounded by the magnetic coil, the stator arrangement including an upper disc and a lower disc attached proximate a first end of the magnetic hub, the upper disc including upper radially extending pole pieces and a the lower disc including lower radially extending pole pieces, the upper and lower radially extending pole pieces alternating angularly, an undulating shielding disc is interposed between adjacent upper and lower pole pieces, the undulating shielding disc passing axially above the lower radially extending pole pieces and axially below the upper radially extending pole pieces shading the upper radially extending pole pieces, the stator including a set of shielded and set of unshielded axially extending pole pieces and an undulating shielding ring interposed between adjacent ones of the shielded and unshielded axially extending pole pieces, the shielding ring passes over a radially outer surface of the unshielded axially extending pole pieces and radially inward of a radially inner surface of the shielded axially extending pole pieces, the magnetic hub including a pair of plastic bearings mounted therein, the rotor shaft passing through central apertures of the plastic bearings and being supported for rotation therein, the annular magnetic flange being positioned within an annular channel formed between the axially extending pole pieces and the radially extending pole pieces.

16. The synchronous motor of claim 15, wherein the plastic bearings have a coefficient of friction of less than 0.15.

17. The synchronous motor of claim 15, wherein the plastic bearings have a deflection temperature of at least 200 degrees Fahrenheit.

18. A synchronous motor including:
a magnetic coil for generating alternating magnetic flux;
a rotor driven by the magnetic flux, the rotor including a rotor shaft coupled to an annular magnetic flange, and
a stator arrangement including a magnetic hub surrounded by the magnetic coil, the hub having at least two plastic bearings mounted therein, the rotor shaft being supported by the plastic bearings, the stator including upper radially extending pole pieces and a plurality of axially extending pole pieces, spaced radially outward in a cylindrical pattern from the ends of the radially extending pole pieces, the pole pieces operably coupled to the magnetic hub, the annular magnetic flange being positioned within an annular channel formed between the axially extending pole pieces and the radially extending pole pieces.

19. The synchronous motor of claim 18, wherein the plastic bearings have a coefficient of friction of less than 0.15 and a deflection temperature of at least 200 degrees Fahrenheit.

20. A valve actuator comprising:
a synchronous motor for providing rotational motion;
a coupling configured to operably rotationally couple the motor to a valve stem of a valve, the motor, when energized, operably driving the coupling from a normal state to a non-normal actuated state;
a gear assembly operably coupled between the motor and the coupling to transfer the rotational output of the synchronous motor to the coupling;
a return spring operably coupled to the gear assembly configured to bias the coupling from the non-normal actuated state to the normal state when the synchronous motor is de-energized; and
the synchronous motor including a magnetic coil for generating alternating magnetic flux;
a rotor driven by the magnetic flux, the rotor including a rotor shaft coupled to an annular magnetic flange, and
a stator arrangement including a magnetic hub surrounded by the magnetic coil, the hub having at least two plastic bearings mounted therein, the rotor shaft being supported by the plastic bearings, the stator including upper radially extending pole pieces and a plurality of axially extending pole pieces, spaced radially outward in a cylindrical pattern from the ends of the radially extending pole pieces, the pole pieces operably coupled to the magnetic hub, the annular magnetic flange being positioned within an annular channel formed between the axially extending pole pieces and the radially extending pole pieces.

21. The valve actuator of claim 20, wherein the plastic bearings have a coefficient of friction of less than 0.15 and a deflection temperature of at least 200 degrees Fahrenheit.
